(19) United States
(12) Patent Application Publication
(10) Pub. No.: US 2024/0407450 A1
(43) Pub. Date: Dec. 12, 2024

(54) AEROSOL-GENERATING DEVICE WITH AMBIENT AIR ADAPTION

(71) Applicant: Philip Morris Products S.A., Neuchatel (CH)

(72) Inventor: Rui Nuno Rodrigues Alves BATISTA, Morges (CH)

(73) Assignee: Philip Morris Products S.A., Neuchatel (CH)

(21) Appl. No.: 18/705,149

(22) PCT Filed: Nov. 3, 2022
(86) PCT No.: PCT/EP2022/080642

§ 371 Date: Apr. 26, 2024

(30) Foreign Application Priority Data
Nov. 5, 2021 (EP) 21206 619.5

(51) Int. Cl. A24F 40/48; A24D 3/17; A24F 40/46; A24F 40/51; A24F 40/57; F24H 3/04; F24H 15/204; F24H 15/25; H05B 3/16

(52) U.S. Cl. CPC A24F 40/48; A24D 3/17; A24F 40/46; A24F 40/51; A24F 40/57; F24H 3/0405; F24H 15/204; F24H 15/25; H05B 3/16; F24H 2250/02; H05B 2203/013; H05B 2203/024

(57) ABSTRACT

An aerosol-generating device is provided, including: an air inlet configured to allow ambient air to enter the aerosol-generating device; an airflow channel fluidly connected with the air inlet; a filter element arranged in the airflow channel adjacent the air inlet and configured to filter the ambient air entering the aerosol-generating device; and a heating element arranged at the airflow channel adjacent the air inlet and configured to heat the ambient air entering the aerosol-generating device, the heating element being further configured to heat the ambient air entering the aerosol-generating device to a temperature of between 15° C. and 35° C.

The present invention relates to an aerosol-generating device.

It is known to provide an aerosol-generating device for generating an inhalable vapor. Such devices may heat aerosol-forming substrate to a temperature at which one or more components of the aerosol-forming substrate are volatilised without burning the aerosol-forming substrate. Aerosol-forming substrate may be provided as part of an aerosol-generating article. A heating element may be arranged in or around the heating chamber for heating the aerosol-forming substrate once the aerosol-generating article is inserted into a heating chamber of the aerosol-generating device. The generated aerosol may be influenced by the temperature and quality of the ambient air being drawn into the aerosol-generating device.

It would be desirable to have an aerosol-generating device able to generate a more uniform aerosol. It would be desirable to have an aerosol-generating device less dependent on the temperature of the ambient air being drawn into the device. It would be desirable to have an aerosol-generating device less dependent on the quality of the ambient air being drawn into the device.

According to an embodiment of the invention there is provided an aerosol-generating device that may comprise an air inlet configured to allow ambient air to enter the aerosol-generating device. The device may further comprise an airflow channel fluidly connected with the air inlet and a filter element arranged in the airflow channel adjacent the air inlet and configured to filter the ambient air entering the aerosol-generating device. The device may further comprise a heating element arranged at the airflow channel adjacent the air inlet and configured to heat the ambient air entering the aerosol-generating device.

According to an embodiment of the invention there is provided an aerosol-generating device comprising an air inlet configured to allow ambient air to enter the aerosol-generating device. The device further comprises an airflow channel fluidly connected with the air inlet and a filter element arranged in the airflow channel adjacent the air inlet and configured to filter the ambient air entering the aerosol-generating device. The device further comprises a heating element arranged at the airflow channel adjacent the air inlet and configured to heat the ambient air entering the aerosol-generating device.

Filtering the ambient air entering the aerosol-generating device may lead to a more uniform aerosol generation. Providing the filter element may lead to a more homogeneous airflow in the aerosol-generating device. Filtering the ambient air entering the aerosol-generating device may lead to a device less dependent upon the quality of the ambient air. Heating the ambient air entering the aerosol-generating device may lead to an aerosol-generating device less dependent on the temperature of the ambient air being drawn into the device. Heating the ambient air entering the aerosol-generating device may lead to a more uniform aerosol generation.

The air inlet may be configured to allow ambient air to be drawn into the device. A wall of the housing of the aerosol-generating device may be provided with the at least one air inlet. The air inlet may be a semi-open inlet. The semi-open inlet may be an inlet which permits air or fluid flow in one direction, such as into the device, but at least restricts, preferably prohibits, air or fluid flow in the opposite direction. The semi-open inlet preferably allows air to enter the aerosol-generating device. Air or liquid may be prevented from leaving the aerosol-generating device through the semi-open inlet. The semi-open inlet may for example be a semi-permeable membrane, permeable in one direction only for air, but is air-and liquid-tight in the opposite direction. The semi-open inlet may for example also be a one-way valve. Preferably, the semi-open inlets allow air to pass through the inlet only if specific conditions are met, for example a minimum depression in the aerosol-generating device or a volume of air passing through the valve or membrane.

The airflow channel may fluidly connect the air inlet with an air outlet of the device. The air outlet may be configured as or part of a mouthpiece. The air outlet may enable a user to inhale the generated aerosol. The airflow channel may be a central airflow channel. The air inlet may be provided at a proximal end face of the device. Alternatively, the air inlet may be a lateral air inlet. The airflow channel may in this case fluidly connect the lateral air inlet with a central portion of the airflow channel. The airflow channel may have a circular or oval or rectangular cross section.

The filter element may comprise a filter. The filter element may be a filter. The filter element may be arranged in the airflow channel such that the air flowing through the airflow channel has to pass the filter element. The filter element may be arranged in the airflow channel such that the ambient air entering the aerosol-generating device flows through the filter element. The filter element may fully occupy at least a portion of the airflow channel. The filter element may fully occupy at least an upstream portion of the airflow channel.

The air may be diffused by the filter element. The air diffused by the filter element may assure that same volume of air, with the same pressure, flows well dispersed within the same volumetric space. This may improve distribution of the air for subsequent aerosolization, strongly contributing to a homogenous aerosolization, producing consistent deliveries during puffing, and also positively contributing to the repeatability of performance between puffs (less variability between puffs).

The filter element may be arranged abutting the air inlet. The filter element may be arranged in direct contact with the air inlet. The filter element may be arranged directly adjacent the air inlet. The filter element may be arranged at a most upstream position of the airflow channel.

The filter element may have a cylindrical shape. The filter element may have a circular or oval or rectangular cross section. The filter element may have the same cross-sectional shape as the airflow channel. The filter element may have an outer diameter corresponding to the inner diameter of the airflow channel. The filter element may preferably be configured as a prismatic parallelepiped body.

As used herein, the terms ‘upstream’, ‘downstream’, ‘proximal’ and ‘distal’ are used to describe the relative positions of components, or portions of components, of the aerosol-generating device in relation to the direction in which a user draws on the aerosol-generating device during use thereof.

The filter element may comprise a porous element. The porous element may be configured as a porous element. The filter element may be fluid permeable.

The filter element may be made of compounds selected from silicon carbide, silicon-based compounds, cordierite, silica and zirconium-based ceramic compounds. The filter element may be particularly preferred made of silica-based sintered porous ceramic material, porous basalt stone materials and/or sintered particles. These materials may be sintered to obtain the desire range of porosity, such as porous silica ceramics produced from silica spinning solutions, where silica particles are introduced by electrospinning, and sintering is then applied to obtain the final desired geometrical shape and size, also obtaining the desired porosity. The sintering process occurs at temperatures of between 1000° C. and 1200° C.

The porosity of such materials is of between 30% and 80%, preferably between 40% and 70%, most preferably between 50% and 60%. The porosity of the material may be adjusted by changing the content of the introduced silica particles, changing its granulometry, which enables to well control the desired porosity. The porosity refers to the pore volume of a defined volume of material (Vp) and its total volume (Vt). Therefore, porosity (Pt) is given by the ratio Vp/Vt. To express porosity as a percent, that decimal is simply multiplied by 100.

This filter element may have a porosity of between 35% and 80%, preferably between 45% and 65%, most preferably between 50% and 60%.

The pore size of the filter material may be between 5 μm and 40 μm, preferably between 5 μm and 30 μm.

The filter element may be made of an electrically non-conductive material. The filter element may be an electrical insulator.

The filter element may be configured to one or both of diffuse and spread the ambient air entering the aerosol-generating device. A more uniform aerosol may therefore be produced by the device.

The air inlet may have an inner diameter of between 0.05 mm and 2 mm, preferably between 0.5 mm and 1.2 mm.

Both of the inner diameter of the air inlet and the characteristics, particularly the porosity, of the filter element may define the resistance to draw of the device. The inner diameter of the air inlet and the characteristics of the filter element may thus be chosen to determine a desired resistance to draw.

The airflow channel may have an inner diameter of between 0.05 mm and 2 mm, preferably between 0.5 mm and 1.2 mm. The filter element may have an outer diameter of between 0.05 mm and 2 mm, preferably between 0.5 mm and 1.2 mm.

The heating element may be configured to heat the ambient air entering the aerosol-generating device to a temperature of between 15° C. and 35° C., preferably between 20° C. and 30° C., more preferably between 22° C. and 28° C., most preferably 25° C.

The heating element may be arranged at least partly surrounding the airflow channel. The heating element may be arranged at least partly surrounding an upstream portion of the airflow channel.

Alternatively, and particularly preferred, the heating element may be one or more of overmolded onto the filter element, printed onto the filter element and impregnated in the filter element. Exemplarily, the heating element may be printed onto the filter element or impregnated in the filter element and subsequently overmolded. In this way, ambient air flowing through the filter element may at the same time be heated by the heating element. In this case, the filter element with the overmolded heating element may be obtained by molding a slurry a compound to generate a porous media with adequate porosity and over-molding it together with the heating element. The compound may be any of the filter element materials described herein, particularly a ceramic material.

Alternatively, the filter element may comprise an upstream segment and a downstream segment. The heating element may be placed between the upstream segment at the downstream segment. Both of the upstream segment at the downstream segment may be porous. The porous upstream portion may differ in terms of porosity comparing to the downstream portion. The downstream portion may have a higher porosity than the upstream portion. The porosity of the downstream portion may be between 25% and 80%, preferably between 55% and 75%, most preferably between 65% and 75%. This may create an improved fluid mechanics of the air flow of easier air flow feeding of the overall volumetric area of the upstream portion, which will be slowed down by the higher porosity of the downstream portion. The downstream portion may offer more resistance to the air flowing through it. This may optimize the heat transfer. This may further enable improved RTD control.

The heating element may be configured to heat the filter element to thereby heat the ambient air entering the aerosol-generating device and flowing through the filter element.

The heating element may be arranged in the airflow channel. The heating element may be arranged in the airflow channel such that the air flowing through the airflow channel has to pass the heating element. The heating element may be fluid-permeable.

The heating element may be arranged in the airflow channel such that the ambient air entering the aerosol-generating device flows through the heating element. The heating element may fully span at least a portion of the airflow channel. The heating element may fully span at least an upstream portion of the airflow channel.

The heating element may be arranged abutting the air inlet. The heating element may be arranged at a most upstream position of the airflow channel. The heating element may have a planar shape. The heating element may have a circular or oval or rectangular cross section. The heating element may have the same cross-sectional shape as the airflow channel. The heating element may have an outer diameter corresponding to the inner diameter of the airflow channel.

The heating element may comprise a mesh heater or may be configured as a mesh heater.

The heating element may be a resistive heater. The heating element may have an output power of between 0.7 W and 2.8 W, preferably of between 0.9 W and 1.7 W. The heating element may be made of a suitable stainless-steel alloy, such as industrial stainless steel 303 and 304 alloys, which have excellent high-temperature oxidation resistance, as well as adequate conductivity and resistivity properties while having good thermal conductivity. The stainless-steel alloys may have a resistivity of about 6.9×10⁷ (Ω·m) at 25° C. The stainless-steel alloys may have a conductivity of about 1.45×10⁶ at 25° C.

In any of the aspects of the disclosure, the heating element may comprise an electrically resistive material. Suitable electrically resistive materials include but are not limited to: semiconductors such as doped ceramics, electrically “conductive” ceramics (such as, for example, molybdenum disilicide), carbon, graphite, metals, metal alloys and composite materials made of a ceramic material and a metallic material. Such composite materials may comprise doped or undoped ceramics. Examples of suitable doped ceramics include doped silicon carbides. Examples of suitable metals include titanium, zirconium, tantalum platinum, gold and silver. Examples of suitable metal alloys include stainless steel, nickel-, cobalt-, chromium-, aluminium-titanium-zirconium-, hafnium-, niobium-, molybdenum-, tantalum-, tungsten-, tin-, gallium-, manganese-, gold-and iron-containing alloys, and super-alloys based on nickel, iron, cobalt, stainless steel, Timetal® and iron-manganese-aluminium based alloys. In composite materials, the electrically resistive material may optionally be embedded in, encapsulated or coated with an insulating material or vice-versa, depending on the kinetics of energy transfer and the external physicochemical properties required.

The heating element may be made of a heating wire or filament, for example a Ni—Cr (Nickel-Chromium), platinum, tungsten or alloy wire or a heating plate.

In case the heating element is arranged at least partly surrounding the airflow channel, the heating element may take the form of one or more flexible heating foils on a dielectric substrate, such as polyimide. The flexible heating foils can be shaped to conform to the perimeter of the airflow channel. Alternatively, the heating element may take the form of a metallic grid or grids, a flexible printed circuit board, a molded interconnect device (MID), ceramic heater, flexible carbon fibre heater or may be formed using a coating technique, such as plasma vapour deposition, on a suitable shaped substrate.

The heating element may be formed using a metal having a defined relationship between temperature and resistivity. The metal may be formed as a track on a suitable insulating material, such as ceramic material, most preferably the filter element. The metal may be sandwiched in another insulating material, such as a glass.

The heating element may be used to both heat and monitor the temperature of the heating elements during operation. The heating element may be made from a material which resistance is indicative of the temperature of the material.

The aerosol-generating device may further comprise a temperature sensor and a controller. The temperature sensor may be configured to measure the temperature of the ambient air entering the aerosol-generating device upstream of the heating element. The controller may be configured to control the heating element based upon the output of the temperature sensor.

The temperature sensor may be adjacent to the air inlet. The temperature sensor may be in communication with the controller to enable the controller to heat the ambient air flowing through the filter element to a predetermined temperature. The temperature sensor may be a thermocouple, or alternatively the heating element may be used to provide information relating to the temperature of the ambient air. The temperature dependent resistive properties of the heating element may be known and used to determine the temperature of the heating element. The temperature of the heating element may be indicative of the temperature of the ambient air before heating operation started. Preferably, however the temperature sensor is configured as a thermocouple.

The controller may be configured to operate the heating element if the temperature sensor detects that the temperature of the ambient air is below 20° C., preferably below 15° C., more preferably below 10° C., most preferably below 5° C.

The controller may be configured to regulate a supply of power to the heating element. Power may be supplied to the heating element continuously following activation of the aerosol-generating device or may be supplied intermittently, such as on a puff-by-puff basis. The power may be supplied to the heating element in the form of pulses of electrical current. The controller may be configured to monitor the electrical resistance of the heating element, and preferably to control the supply of power to the heating element dependent on the electrical resistance of the heating element.

The aerosol-generating device may comprise a power supply, typically a battery, within a main body of the aerosol-generating device. In one embodiment, the power supply is a Lithium-ion battery. Alternatively, the power supply may be a Nickel-metal hydride battery, a Nickel cadmium battery, or a Lithium based battery, for example a Lithium-Cobalt, a Lithium-Iron-Phosphate, Lithium Titanate or a Lithium-Polymer battery. As an alternative, the power supply may be another form of charge storage device such as a capacitor. The power supply may require recharging and may have a capacity that enables to store enough energy for one or more usage experiences; for example, the power supply may have sufficient capacity to continuously generate aerosol for a period of around six minutes or for a period of a multiple of six minutes. In another example, the power supply may have sufficient capacity to provide a predetermined number of puffs or discrete activations of the heating element.

As used herein, an ‘aerosol-generating device’ relates to a device that interacts with an aerosol-forming substrate to generate an aerosol. The aerosol-forming substrate may be part of an aerosol-generating article, for example part of a smoking article. An aerosol-generating device may be a smoking device that interacts with an aerosol-forming substrate of an aerosol-generating article to generate an aerosol that is directly inhalable into a user's lungs thorough the user's mouth. An aerosol-generating device may be a holder. The device may be an electrically heated smoking device. The aerosol-generating device may comprise a housing, electric circuitry, a power supply, a heating chamber and a heating element.

The aerosol-generating device may comprise a mouthpiece. The mouthpiece may comprise first and second planar susceptors that are arranged distanced and parallel to each other. The mouthpiece may comprise an extension-and-retraction element configured to at least partly retract the first and second susceptors into the mouthpiece into a retracted position for ejecting the consumable.

The aerosol-generating device may comprise a heating compartment. The heating compartment may comprise an inductor. The heating compartment may be configured removably connectable to the mouthpiece. The heating compartment may comprise a heating chamber and an inductor. The inductor may be located outside the heating chamber. The inductor may be thermally shielded from the heating chamber. For example, the heating compartment may comprise a heating chamber having a rectangular cross-section. The heating chamber may be sandwiched between a first planar induction coil located above the heating chamber and a second planar induction coil located below the heating chamber. Layers of thermally insulating material may be provided between the heating chamber and the first and second coils, respectively. The heating compartment may be configured removably connectable to the mouthpiece via first connection elements. The first connection elements may comprise one or more of form-locking connection elements, force-locking connection elements and snap-fit connection elements. The heating compartment may comprise a cavity for receiving a planar consumable comprising aerosol-forming substrate. The cavity may be configured as a heating chamber for heating the aerosol-forming substrate of the consumable. The heating compartment may comprise at least one temperature sensor configured to measure the temperature of one or both of the first and second susceptors. The controller may be configured to control supply of electrical energy from the power supply to the inductor on basis of the output of the at least one temperature sensor of the heating compartment.

The aerosol-generating device may comprise a main body. The main body may comprise a power supply. The main body may be removably connectable to the heating compartment. The main body may be removably connectable to the heating compartment via second connection elements. The second connection elements may comprise one or more of form-locking connection elements, force-locking connection elements and snap-fit connection elements. The inductor may comprise at least one induction coil. The inductor may comprise a first induction coil and a second induction coil. One or both of the first and second induction coils may be planar. The main body may comprise a controller and DC/AC converter configured to control supply of an alternating current from the power supply to the inductor.

The aerosol-generating substrate may comprise an aerosol-former. The aerosol-generating substrate preferably comprises homogenised tobacco material, an aerosol-former and water. Providing homogenised tobacco material may improve aerosol generation, the nicotine content and the flavour profile of the aerosol generated during heating of the aerosol-generating article. Specifically, the process of making homogenised tobacco involves grinding tobacco leaf, which more effectively enables the release of nicotine and flavours upon heating.

Alternatively, the aerosol-forming substrate may be a liquid aerosol-forming substrate and contained in a liquid storage portion of the aerosol-generating device.

Resistance to draw is also known as draft resistance, draw resistance, puff resistance or puffability, and is the pressure required to force air through the full length of the object under test at the rate of 17.5 ml/sec at 22° C. and 760 Torr (101 kPa). It is typically expressed in units of mmH20 and is measured in accordance with ISO 6565:2002. The air inlet and particularly the filter element advantageously together provide an RTD of between 10 and 65 mmH20 through the airflow channel.

Features described in relation to one embodiment may equally be applied to other embodiments of the invention.

The invention will be further described, by way of example only, with reference to the accompanying drawings in which:

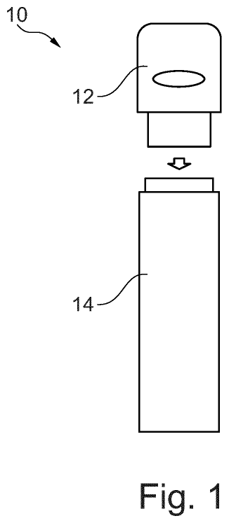

FIG. 1 shows an exemplary aerosol-generating device according to the invention;

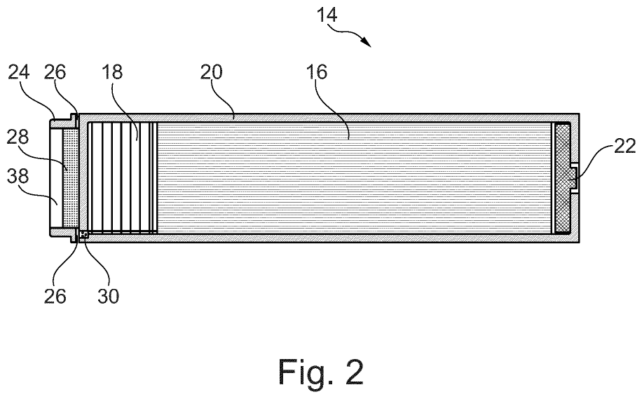

FIG. 2 shows a main body of the aerosol-generating device;

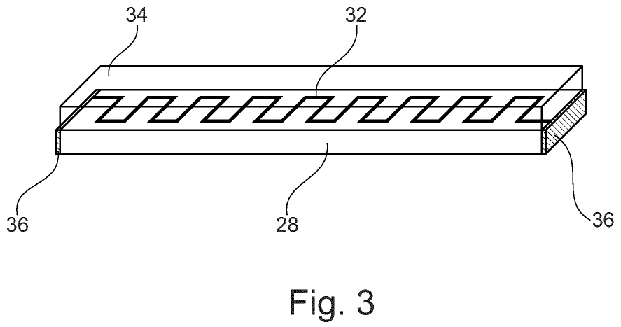

FIG. 3 shows a heating element of the aerosol-generating device.

FIG. 1 shows an exemplary aerosol-generating device 10. The aerosol-generating device 10 comprises a mouthpiece 12 that is configured attachable to a main body 14 of the aerosol-generating device 10. Alternatively, the mouthpiece 12 may be integrated into the aerosol-generating device 10. As a further alternative, further elements of the aerosol-generating device 10 may be attachable between the mouthpiece 12 and the main body 14 of the aerosol-generating device 10.

FIG. 2 shows the main body 14 of the aerosol-generating device 10 in more detail. A power supply 16 in the form of a battery as well as a controller 18 is arranged within a housing 20 of the main body 14.

At the downstream or a distal end of the main body 14, a data and charging port 22 is provided. At the upstream or proximal end of the main body 14, protruding walls 24 are provided for attachment of the main body 14 with the mouthpiece 12. However, as indicated, the mouthpiece 12 or a different element of the aerosol-generating device 10 may be integrated with the main body 14. The protruding walls 24 may comprise one or both of mechanical and magnetic connection elements to enable a connection with the mouthpiece 12 or with a different modular element.

FIG. 2 further shows air inlets 26 arranged in the housing 20 of the main body 14. The air inlets 26 are configured as lateral air inlets 26. The air inlets 26 are arranged adjacent the upstream end of the main body 14. The air inlets 26 are configured to enable ambient air to be drawn into the aerosol-generating device 10, particularly into an airflow channel 38 of the aerosol-generating device 10.

The air inlets 26 may alternatively be placed anywhere else in the aerosol-generating device 10. Exemplarily, the air inlets 26 may be arranged at the upstream end of the aerosol-generating device 10. Alternatively, the air inlets 26 may be arranged in the mouthpiece 12. As a further alternative, a single air inlet may be provided instead of at least two air inlets 26 as shown in FIG. 2.

Adjacent the air inlets 26, a filter element 28 is arranged. The filter element 28 has a rectangular cross-sectional shape. The filter element 28 is made of a ceramic material. The filter element 28 is porous. The filter element 28 is fluid permeable. The filter element 28 allows ambient air to be drawn through the filter element 28. The ambient air is filtered that by the filter element 28. The ambient air is then drawn towards the mouthpiece 12, particularly towards an air outlet in the mouthpiece 12 so that the air can be inhaled by a user. In the embodiment shown in FIGS. 1 and 2, the mouthpiece 12 is configured to generate an inhalable aerosol. Alternatively, the aerosol generation can be facilitated in the main body 14, in which case the aerosol generation will take place downstream of the filter element 28.

FIG. 2 further shows a temperature sensor 30. The temperature sensor 30 is preferably configured as a thermocouple. The temperature sensor 30 is arranged adjacent an air inlet such that the temperature sensor 30 can detect the temperature of the ambient air that is drawn into the aerosol-generating device 10. The temperature sensor 30 is electrically connected with the controller 18 by appropriate wiring. The temperature sensor 30 is configured to detect the temperature of the ambient air and to output a corresponding signal to the controller 18. The controller 18 is configured to receive the output of the temperature sensor 30. The controller 18 is configured to control supply of electrical energy from the power supply 16 to a heating element 32 described in more detail below with reference to FIG. 3. The controller 18 is configured to control the supply of electrical energy on basis of the output of the temperature sensor 30. If the ambient air is too cold, the temperature of the ambient air is increased by the controller 18 operating the heating element 32.

FIG. 3 shows the heating element 32 in more detail. The heating element 32 is provided as a heating track on a substrate. The substrate is the filter element 28. In the embodiment shown in FIG. 3, the heating element 32 is overmolded onto the filter element 28. The heating element 32 is overmolded with a porous material 34. This leads to a porous and fluid permeable heating element 32 such that the ambient air can be drawn through the filter element 28 and further through the heating element 32. The ambient air is thus filtered by the filter element 28 and at the same time heated such that a high-quality ambient air with a controlled temperature is provided for improved aerosol generation.

FIG. 3 further shows electrical contacts 36 for a contacting the heating element 32 with one or both of the controller 18 and the power supply 16. The electrical contacts 36 are configured such that electrical energy can be supplied from the power supply 16 to the heating element 32 to heat the heating element 32.

The heating element 32 of FIG. 3 is overmolded onto the filter element 28 of FIG. 2 or printed onto the heating element 32 of FIG. 2.

1.-15. (canceled)

16. An aerosol-generating device, comprising:
an air inlet configured to allow ambient air to enter the aerosol-generating device;
an airflow channel fluidly connected with the air inlet;
a filter element arranged in the airflow channel adjacent the air inlet and configured to filter the ambient air entering the aerosol-generating device; and
a heating element arranged at the airflow channel adjacent the air inlet and configured to heat the ambient air entering the aerosol-generating device, wherein the heating element is further configured to heat the ambient air entering the aerosol-generating device to a temperature of between 15° C. and 35° C.

17. The aerosol-generating device according to claim 16, wherein the filter element comprises a porous element.

18. The aerosol-generating device according to claim 16, wherein the filter element is configured as a porous element.

19. The aerosol-generating device according to claim 16, wherein the filter element is further arranged in the airflow channel such that the ambient air entering the aerosol-generating device flows through the filter element.

20. The aerosol-generating device according to claim 16, wherein the filter element is further configured to one or both of diffuse and spread the ambient air entering the aerosol-generating device.

21. The aerosol-generating device according to claim 16, wherein the heating element is further configured to heat the ambient air entering the aerosol-generating device to a temperature of between 20° C. and 30° C.

22. The aerosol-generating device according to claim 16, wherein the heating element is further configured to heat the ambient air entering the aerosol-generating device to a temperature of 25° C.

23. The aerosol-generating device according to claim 16, wherein the heating element is further arranged at least partly surrounding the airflow channel.

24. The aerosol-generating device according to claim 16,
wherein the aerosol-generating device further comprises a temperature sensor and a controller,
wherein the temperature sensor is configured to measure a temperature of the ambient air entering the aerosol-generating device upstream of the heating element, and
wherein the controller is configured to control the heating element based upon an output of the temperature sensor.

25. The aerosol-generating device according to claim 24, wherein the controller is further configured to operate the heating element if the temperature sensor detects that the temperature of the ambient air is below 20° C.

26. The aerosol-generating device according to claim 24, wherein the controller is further configured to operate the heating element if the temperature sensor detects that the temperature of the ambient air is below 5° C.

27. The aerosol-generating device according to claim 16, wherein the heating element is overmolded onto the filter element.

28. The aerosol-generating device according to claim 16, wherein the heating element is printed onto the filter element.

29. The aerosol-generating device according to claim 16, wherein the heating element is further configured to heat the filter element to thereby heat the ambient air entering the aerosol-generating device.

30. The aerosol-generating device according to claim 16, wherein the heating element is further arranged in the airflow channel.

31. The aerosol-generating device according to claim 16, wherein the heating element is fluid-permeable.

32. The aerosol-generating device according to claim 16, wherein the filter element is made of a ceramic material.

33. The aerosol-generating device according to claim 16, wherein the filter element has a porosity of between 30% and 80%.

34. The aerosol-generating device according to claim 16, wherein the filter element has a porosity of between 50% and 60%.
